(19) United States
(12) Patent Application Publication
(10) Pub. No.: US 2014/0217026 A1
(43) Pub. Date: Aug. 7, 2014

(54) DRAW SOLUTE FOR FORWARD OSMOSIS, FORWARD OSMOSIS WATER TREATMENT DEVICE, AND FORWARD OSMOSIS METHOD FOR WATER TREATMENT

(71) Applicant: Samsung Electronics Co., Ltd., Suwon-Si (KR)

(72) Inventors: Jung Im HAN, Yongin-si (KR); Bo Kyung JUNG, Yongin-si (KR); Sung Soo HAN, Hwaseong-si (KR); Jae Eun KIM, Hwaseong-si (KR)

(73) Assignee: SAMSUNG ELECTRONICS CO., LTD., Suwon-Si (KR)

(21) Appl. No.: 14/077,284

(22) Filed: Nov. 12, 2013

(30) Foreign Application Priority Data
Feb. 4, 2013 (KR) 10-2013-0012419

(51) Int. Cl. C02F 1/44

(52) U.S. Cl. CPC C02F 1/445
USPC 210/644; 210/321.6; 210/195.2; 252/180; 526/287; 522/33

(57) ABSTRACT

A method of manufacturing polymer hydrogel for an osmosis solute may include cross-linking polymerizing a zwitterionic monomer (including an anionic group and a cationic group) and a temperature-sensitive monomer. Example embodiments also relate to a draw solute for forward osmosis including polymer hydrogel manufactured according to the method, and a forward osmosis water treatment device and method using the forward osmosis draw solute.

### CROSS-REFERENCE TO RELATED APPLICATION

This application claims priority under 35 U.S.C. §119 to Korean Patent Application No. 10-2013-0012419, filed in the Korean Intellectual Property Office on Feb. 4, 2013, the entire contents of which are incorporated herein by reference.

### BACKGROUND

1. Field

Example embodiments relate to a draw solute for forward osmosis, a forward osmosis water treatment device using the same, and a forward osmosis method for water treatment using the same.

2. Description of the Related Art

In general, desalination through reverse osmosis is commonly known in the field of water treatment. Osmosis refers to a phenomenon in which water in a portion of low concentration moves to a solution of high concentration, and reverse osmosis desalination is a process of artificially adding high pressure to move water in the opposite direction, thereby producing fresh water. Since the reverse osmosis requires a relatively high pressure, it has a relatively high energy consumption. Recently, to increase energy efficiency, forward osmosis that uses the principle of osmotic pressure has been suggested and a solute for the osmosis draw solution including ammonium bicarbonate, sulfur dioxide, aliphatic alcohols, aluminum sulfate, glucose, fructose, potassium nitrate, and the like have been used. Among them, an ammonium bicarbonate draw solution is most commonly known, which may be decomposed into ammonia and carbon dioxide and separated at a temperature of about 60° C. after forward osmosis. Further, newly suggested draw solution materials include magnetic nanoparticles having a hydrophilic peptide attached thereto (separated by a magnetic field), a polymer electrolyte such as a dendrimer (separated by a UF or NF membrane), and the like.

In the case of ammonium bicarbonate, it should be heated to about 60° C. or more so as to be vaporized, thus requiring a relatively high energy consumption, and since complete removal of ammonia is relatively difficult, it is not practical to use it as drinking water due to the odor of ammonia. In the case of the magnetic nanoparticles, it is relatively difficult to redisperse magnetic particles that are separated and agglomerated by a magnetic field, and it is also relatively difficult (if not impossible) to completely remove the nanoparticles, and thus toxicity of the nanoparticles should be considered. Polymer ion (dendrimer, protein, etc.) technology requires a nanofiltration or ultrafiltration membrane filter due to the size of the polymer of several to dozens of tens of nanometers, and it is also relatively difficult to redisperse the agglomerated polymer after filtering.

### SUMMARY

Some example embodiments relate to a method of manufacturing a draw solute for forward osmosis having a relatively low energy requirement for separation and recovery.

Some example embodiments relate to a draw solute for forward osmosis manufactured according to the above-mentioned method.

Some example embodiments relate to a forward osmosis water treatment device including the draw solute for forward osmosis.

Some example embodiments relate to a forward osmosis method for water treatment using the draw solute for forward osmosis.

In one example embodiment, a method of manufacturing a polymer hydrogel for an osmosis solute may include cross-linking polymerizing a zwitterionic monomer (including an anionic group and a cationic group) and a temperature-sensitive monomer.

In another example embodiment, a method of manufacturing a polymer hydrogel for an osmosis solute may include (a) cross-linking polymerizing a zwitterionic monomer including an anionic group and a cationic group, and (b) cross-linking polymerizing a temperature-sensitive monomer, wherein the polymer hydrogel is manufactured by first performing one of processes (a) and (b) to initially manufacture a cross-linked copolymer, and then adding the cross-linked copolymer to the cross-linking polymerization reactant of the other process to perform a cross-linking polymerization.

In the manufacturing method, the zwitterionic monomer including an anionic group and a cationic group may be represented by the following Chemical Formula 1:

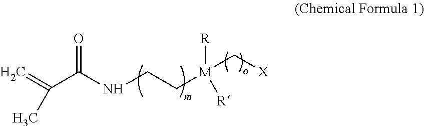

In the above Chemical Formula 1, X is an anionic group, M is a cationic group, R and R′ are independently a saturated or unsaturated monovalent organic group, m is an integer ranging from 0 to 10, and o is an integer ranging from 1 to 10.

The temperature-sensitive monomer is a compound that may be polymerized to be a temperature-sensitive polymer by a radical reaction, for example thermal radical reaction, and has a structure of a hydrophilic moiety and a hydrophobic moiety. Specifically, the hydrophilic moiety may include amide, and the hydrophobic moiety may include a hydrocarbon group of alkyl, alkenyl, alkynyl, and the like.

For non-limiting examples, the temperature-sensitive monomer may include the following compounds:

NIPAM (N-isopropylacrylamide) represented by the following Chemical Formula 2:

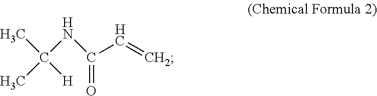

N,N-Diethylacrylamide represented by the following Chemical Formula 3:

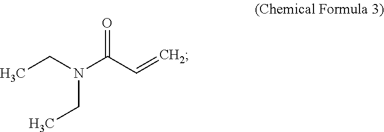

N-vinylcaprolactam (VCL) represented by the following Chemical Formula 4:

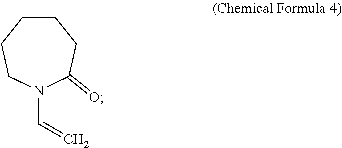

2-isopropyl-2-oxazoline represented by the following Chemical Formula 5:

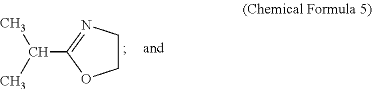

vinyl methyl ether represented by the following Chemical Formula 6:

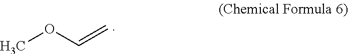

In the manufacturing method, the cross-linking polymerization reaction may be performed using a cross-linking agent represented by the following Chemical Formula 7:

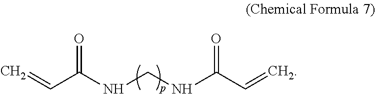

In the above Chemical Formula 7, p is an integer ranging from 1 to 10.

In the manufacturing method, the cross-linking polymerization reaction may be performed in the presence of a photopolymerization initiator.

In another example embodiment, a draw solute for forward osmosis including a polymer hydrogel including a unit represented by the following Chemical Formula 8 is provided:

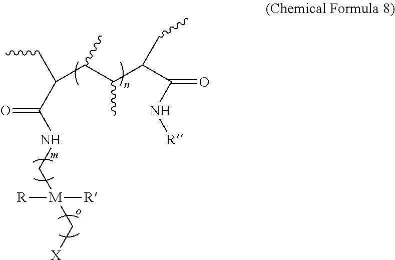

In the above Chemical Formula 8, R, R′ and R″ are independently a saturated or unsaturated monovalent organic group, X is an anionic group, M is a cationic group, m and o are the same or different and are integers ranging from 1 to 10, n is an integer ranging from 1 to 20, and [symbol] indicates a moiety linked to another moiety.

In yet another example embodiment, a draw solute for forward osmosis may include a polymer hydrogel where a first cross-linked polymer including a zwitterionic monomer (including an anionic group and a cationic group) and a second cross-linked polymer including a temperature-sensitive monomer form interpenetrating polymer networks (IPN).

The first and second cross-linked polymers forming the interpenetrating polymer networks (IPN) may be cross-linking polymerized with a cross-linking agent.

The cross-linking agent may be represented by the above Chemical Formula 7.

The zwitterionic monomer may be a monomer represented by the above Chemical Formula 1.

The temperature-sensitive monomer may be one or more of the monomers represented by the above Chemical Formulae 2 to 6.

In still another example embodiment, a forward osmosis water treatment device may include the draw solute for forward osmosis.

Specifically, the forward osmosis water treatment device may include a chamber including a first part for receiving a feed solution including subject materials to be separated for purification, and a second part for receiving an osmosis draw solution including a draw solute for forward osmosis; a semi-permeable membrane disposed between the first part and the second part in the chamber, one side being toward the first part and the other side being toward the second part; and a recovery system for separating and recovering the draw solute for forward osmosis from the osmosis draw solution, wherein the draw solute for forward osmosis is attached to the surface of the semi-permeable membrane toward the second part.

In another example embodiment, a forward osmosis method for water treatment may use the draw solute.

### BRIEF DESCRIPTION OF THE DRAWINGS

FIG. 1 is a schematic view showing reversible changes of a polymer hydrogel (including a temperature-sensitive monomer) from a hydrophilic state to a hydrophobic state (and vice versa) depending on changes of temperature or pH, and water uptake and dehydration principles therewith.

FIG. 2 is a schematic view showing an interpenetrating (IPN) polymer structure of a cross-linked polymer (solid line) including a zwitterionic monomer and a cross-linked polymer (a dotted line) including a temperature-sensitive monomer.

FIG. 3 is a schematic view showing a forward osmosis water treatment device according to one example embodiment.

FIG. 4 is a photograph showing a polymer hydrogel before water uptake (left) and swollen after the water uptake (right) according to one example embodiment.

FIG. 5 is a schematic view showing a water treatment process using a separation membrane manufactured by adhering a polymer hydrogel to the rear of a semi-permeable membrane according to one example embodiment.

FIG. 6 is a drawing schematically showing a method of measuring water flux of a separation membrane for water treatment including a polymer hydrogel according to one example embodiment.

FIG. 7 is a scanning electron microscope (SEM) photograph (the upper photograph enlarges the bottom photograph) showing the cross-section of a separation membrane manufactured by adhering an IPN polymer hydrogel to the rear of a semi-permeable membrane (a PS membrane) according to an example embodiment.

FIG. 8 is a graph showing the swelling ratio comparison of a polymer (PNIPAm) prepared by polymerizing a temperature-sensitive monomer (NIPAM), a copolymer (PNIPAm:AA) prepared by copolymerizing the polymer (PNIPAm) with an acrylic acid monomer (AA), and a copolymer (PNIPAm:AA+SSP) prepared by forming the copolymer (PNIPAm:AA) and a polymer including an amphiphilic monomer (SPP) into an IPN copolymer.

FIG. 9 is a graph showing the total water treatment performance comparison of the polymer hydrogels synthesized according to Examples and Comparative Examples.

### DETAILED DESCRIPTION

This disclosure will be described more fully hereinafter in the following detailed description. This disclosure may be embodied in many different forms and is not be construed as limited to the example embodiments set forth herein.

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As used herein, when a definition is not otherwise provided, the term “substituted” may refer to one substituted with a hydroxy group, a nitro group, a cyano group, an imino group (═NH or ═NR′, where R′ is a C1 to C10 alkyl group), an amino group (—NH₂, —NH(R″ or —N(R″)(R′″), where R″ to R′ are each independently a C1 to C10 alkyl group), an amidino group, a hydrazine group, a hydrazone group, a carboxyl group, a C1 to C30 alkyl group, a C1 to C10 alkylsilyl group, a C3 to C30 cycloalkyl group, a C6 to C30 aryl group, a C2 to C30 heteroaryl group, a C1 to C10 alkoxy group, a halogen, a C1 to C10 fluoroalkyl group such as a trifluoromethyl group, and the like.

As used herein, when a definition is not otherwise provided, the prefix “hetero” may refer to one including 1 to 3 heteroatoms selected from N, O, S, and P, with the remaining structural/backbone atoms in a compound or a substituent being carbons.

As used herein, when a definition is not otherwise provided, the term “combination thereof” refers to at least two substituents bound to each other by a linker, or at least two substituents condensed to each other.

As used herein, “*” may refer to an attachment point to the same or different atom or chemical formula.

As used herein, when a definition is not otherwise provided, the term “alkyl group” may refer to a “saturated alkyl group” without an alkenyl or alkynyl, or an “unsaturated alkyl group” without at least one alkenyl or alkynyl. The “alkenyl group” may refer to a substituent in which at least two carbon atoms are bound in at least one carbon-carbon double bond, and the term “alkyne group” refers to a substituent in which at least two carbon atoms are bound in at least one carbon-carbon triple bond.

The alkyl group may be a C1 to C30 linear or branched alkyl group, and more specifically a C1 to C6 alkyl group, a C7 to C10 alkyl group, or a C11 to C20 alkyl group.

For example, a C1-C4 alkyl may have 1 to 4 carbon atoms, and may be selected from the group consisting of methyl, ethyl, propyl, iso-propyl, n-butyl, iso-butyl, sec-butyl, and t-butyl.

Examples of the alkyl group include a methyl group, an ethyl group, a propyl group, an isopropyl group, a butyl group, an isobutyl group, a t-butyl group, a pentyl group, a hexyl group, an ethenyl group, a propenyl group, a butenyl group, a cyclopropyl group, a cyclobutyl group, a cyclopentyl group, a cyclohexyl group, and the like.

The term “aromatic group” may refer a substituent including a cyclic structure where all elements have p-orbitals which form conjugation. Examples include an aryl group and a heteroaryl group.

The term “aryl group” may refer to monocyclic or fused ring-containing polycyclic (i.e., rings sharing adjacent pairs of carbon atoms) groups.

The “heteroaryl group” may refer to one including 1 to 3 heteroatoms selected from N, O, S, or P in an aryl group, with the remaining structural/backbone atoms being carbons. When the heteroaryl group is a fused ring, each ring may include 1 to 3 heteroatoms.

Hereinafter, example embodiments have been described to facilitate the understanding of a person having an ordinary skill in the art. However, it should be understood that this disclosure may be embodied in many different forms and is not limited to the example embodiments.

In one example embodiment, a method of manufacturing a polymer hydrogel for an osmosis solute may include cross-linking polymerizing a zwitterionic monomer (including an anionic group and a cationic group) and a temperature-sensitive monomer.

In the manufacturing method, the zwitterionic monomer including an anionic group and a cationic group may be represented by the following Chemical Formula 1:

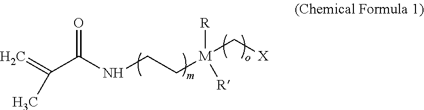

In the above Chemical Formula 1, X is an anionic group, M is a cationic group, R and R′ are each saturated or unsaturated monovalent organic group, m is an integer ranging from 0 to 10, and o is an integer ranging from 1 to 10.

Specifically, m may be an integer ranging from 0 to 5, and more specifically 1 to 3, and o may be an integer ranging from 1 to 10, specifically 1 to 5, and more specifically 1 to 3.

Specifically, the anionic group X may be selected from —COO⁻, —CO₃⁻, —SO⁻₃, —SO₂⁻, —SO₂NH⁻, —NH₂⁻, —PO₃⁻², —PO₄⁻, —CH₂OPO₃⁻, —(CH₂O)₂PO₂⁻, —C₆H₄O⁻, —OSO₃⁻, —SO₂NR⁻, —SO₂NSO₂R⁻, —SO₂CRSO₂R′⁻ (wherein, R and R′ are each independently C1 to C4 alkyl or C7 to C11 arylalkyl), —Cl⁻, —Br, —SCN⁻, —ClO⁴⁻ and a combination thereof.

Specifically, the cationic group M may be selected from an amino group, an ammonium group, a pyridinium group, and a combination thereof.

The saturated or unsaturated organic group may be an aliphatic organic group, an alicyclic organic group, an aromatic organic group, and the like, specifically a substituted or unsubstituted alkyl group, a substituted or unsubstituted alkenyl group, a substituted or unsubstituted alkynyl group, a substituted or unsubstituted aryl group, a substituted or unsubstituted arylalkyl group, a substituted or unsubstituted arylalkenyl group, or a substituted or unsubstituted arylalkynyl group, without limitation.

The temperature-sensitive monomer is a compound that may be polymerized to be a temperature-sensitive polymer by a radical reaction, and has a structure of a hydrophilic moiety and a hydrophobic moiety. The hydrophilic moiety may include amide, and the hydrophobic moiety may include a hydrocarbon group of alkyl, alkenyl, alkynyl, and the like. The temperature-sensitive monomer may have various structures, and forms a gel when a temperature increases.

For non-limiting examples of the temperature-sensitive monomer, NIPAM (N-isopropylacrylamide) represented by the following Chemical Formula 2 which is polymerized to be PNIPAM (poly(N-isopropylacrylamide)):

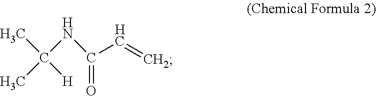

N,N-diethylacrylamide represented by the following Chemical Formula 3 which is polymerized to be PDEAAM (poly(N,N,-diethylacrylamide)):

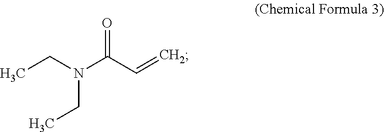

N-vinylcaprolactam (VCL) represented by the following Chemical Formula 4 which is polymerized to be PVCL (poly(N-vinylcaprolactam)):

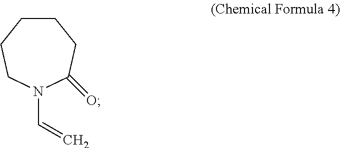

2-isopropyl-2-oxazoline represented by the following Chemical Formula 4 which is polymerized to be PIOZ (poly (2-isopropyl-2-oxazoline)):

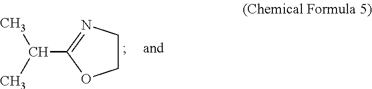

vinyl methyl ether represented by the following Chemical Formula 6 which is polymerized to be PVME (poly(vinyl methyl ether)):

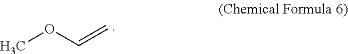

The term ‘temperature-sensitive’ may refer to reversible self-agglomeration depending on changes of temperature, since water solubility difference between high temperature and low temperature is large. The temperature-sensitive monomers represented by above Chemical Formula 2 to Chemical Formula 6 have high hydrophilicity at a low temperature and are soluble in water, but are self-agglomerated at ‘low critical solution temperature (LOST)’ or more. Accordingly, a polymer having such a low critical solution temperature (LOST) has been used as an osmosis draw solute, but as described below, in the present embodiment, a method of manufacturing osmosis draw solute includes cross-linking polymerizing the monomer to prepare a polymer hydrogel.

In the manufacturing method, the cross-linking polymerization reaction may be performed using a cross-linking agent represented by the following Chemical Formula 7:

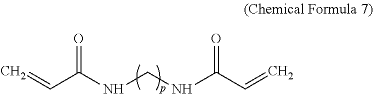

In the above Chemical Formula 7, p is an integer ranging from 1 to 10, and specifically 3 to 5.

In the manufacturing method, the cross-linking polymerization reaction may be performed in the presence of a photopolymerization initiator. The photopolymerization initiator may be well-known IRGACURE 2959 (2-hydroxy-1-[4-(2-hydroxyethoxy)phenyl]-2-methyl-1-propanone), IRGACURE 500 (1-Hydroxy-cyclohexyl-phenyl-ketone+benzophenone), IRGACURE 754 (oxy-phenyl-acetic acid 2-[2 oxo-2 phenyl-acetoxy-ethoxy]-ethyl ester, and oxy-phenyl-acetic 2-[2-hydroxy-ethoxy]-ethyl ester), and the like, but is not limited thereto.

In another example embodiment, a draw solute for forward osmosis may include a polymer hydrogel manufactured according the manufacturing method. The polymer hydrogel includes a unit represented by the following Chemical Formula 8 and is obtained by copolymerizing a zwitterionic monomer including a cationic group and an anionic group, and a temperature-sensitive monomer:

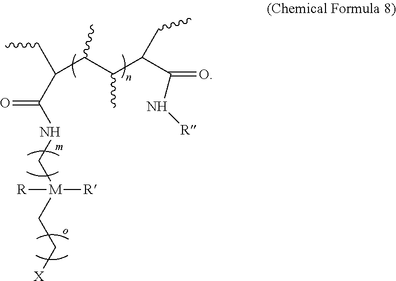

In the above Chemical Formula 8, R, R′ and R″ are independently a saturated or unsaturated monovalent organic group, X is an anionic group, M is a cationic group, m and o are the same or different and are integers ranging from 1 to 10, n is an integer ranging from 1 to 20, and [symbol] indicates a moiety linked to another moiety.

The saturated or unsaturated organic group may be an aliphatic organic group, an alicyclic organic group, an aromatic organic group, and the like, and specifically a substituted or unsubstituted alkyl group, a substituted or unsubstituted alkenyl group, a substituted or unsubstituted alkynyl group, a substituted or unsubstituted aryl group, a substituted or unsubstituted arylalkyl group, a substituted or unsubstituted arylalkenyl group, or a substituted or unsubstituted arylalkynyl , without limitation.

The above Chemical Formula 8 indicates a cross-linking copolymerized polymer of the zwitterionic monomer represented by the above Chemical Formula 1, and including an anionic group and a cationic group in the molecule; and the temperature-sensitive monomer represented by any one of the above Chemical Formulae 2 to 5, and including a hydrophilic group and a hydrophobic group in the molecule, which may be prepared by cross-linking copolymerized by using a cross-linking agent represented by the above Chemical Formula 7.

The copolymer is a cross-linking copolymer having a net structure by cross-linking copolymerizing the zwitterionic monomer, the temperature-sensitive monomer, or the cross-linking agent in parts represented by “ [symbol] ” in the above Chemical Formula 8, using the cross-linking agent represented by the above Chemical Formula 7.

A draw solute for forward osmosis including the polymer hydrogel may include a side chain derived from the temperature-sensitive monomer, and a zwitterionic side chain including an anionic group and a cationic group as in the above Chemical Formula 8. Thereby, higher water flux and water recovery at a low temperature may be realized.

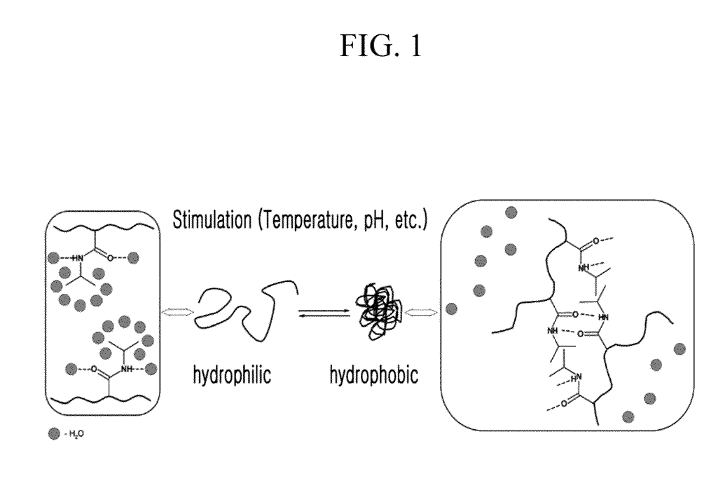

FIG. 1 is a schematic view showing reversible changes of a polymer hydrogel including a temperature-sensitive monomer from a hydrophilic state to a hydrophobic state (and vice versa) depending on changes of temperature or pH, and water uptake and dehydration principles.

Referring to FIG. 1, a polymer including a temperature-sensitive monomer is hydrophilic and dissolved in water at a low temperature, since the amine group and an oxygen atom of the temperature-sensitive monomer form hydrogen bonds with water molecules. However, when the polymer is heated or pH is changed, the hydrogen bonds of the temperature-sensitive monomers with the water molecules are broken, but the amine groups of the temperature-sensitive monomers form hydrogen bonds with oxygen atoms, which lead to agglomeration among the temperature-sensitive monomers and furthermore, among the polymers including the temperature-sensitive monomers. Accordingly, when the polymer including the temperature-sensitive monomer is used as an osmosis draw solute, the water uptake in the polymer hydrogel is dehydrated from the polymer due to an osmosis phenomenon according to changing a temperature or pH, and accordingly, the polymer is self-agglomerated. Therefore, the agglomerated polymer may be separated and reused as an osmosis draw solute.

Herein, a high water flux may be obtained by increasing hydrophilic property of the polymer. However, when an ionic group is introduced into the polymer so as to increase the hydrophilic property of the polymer, LOST, that is, a low critical solution temperature is sharply increased. Accordingly, the polymer hydrogel may be dehydrated at a higher temperature, and thus, higher energy for water treatment is required.

However, a draw solute having a side chain derived from a monomer including an anionic group and a cationic group may maintain a hydrophilic property due to ionic property of a polymer as the draw solute and simultaneously, prevent sharp increase of LOST of the temperature-sensitive monomer during the water recovery at greater than or equal to the LOST due to mutual compensation of the anionic and cationic groups.

Accordingly, higher water flux, as well as water recovery at a lower temperature, may be accomplished.

In another example embodiment, a method of manufacturing a polymer hydrogel for an osmosis solute may include (a) cross-linking polymerizing a zwitterionic monomer including an anionic group and a cationic group, and (b) cross-linking polymerizing a temperature-sensitive monomer, wherein the polymer hydrogel is manufactured by first performing one of processes (a) and (b) to initially manufacture a cross-linked copolymer, and then adding the cross-linked copolymer to a cross-linking polymerization reactant of the other process to perform a cross-linking polymerization.

In the manufacturing method, the zwitterionic monomer including an anionic group and a cationic group and temperature-sensitive monomer may be the same as described above.

The cross-linking polymerization reaction may be performed using the cross-linking agent and photopolymerization initiator that are described above.

As described above, a polymerization method may include first performing one of processes (a) and (b) to manufacture a cross-linked copolymer, and then adding the cross-linked copolymer to a cross-linking polymerization reactant of the other process to perform a cross-linking polymerization.

According to the example embodiment, when the zwitterionic monomer including an anionic group and a cationic group is not copolymerized with the temperature-sensitive monomer, and each monomer independently forms a cross-linked polymer. However, the later cross-linking polymerized monomers undergo cross-linking polymerization reaction in the presence of the first cross-linking polymerized monomer, and the resultant polymer hydrogel may have a interpenetrating polymer network (IPN) structure where each of the monomers are independently cross-linking polymerized to form two kinds of polymer hydrogels and two kinds of polymer hydrogels are interpenetrated into each other to act as one kind of hybrid polymer hydrogel.

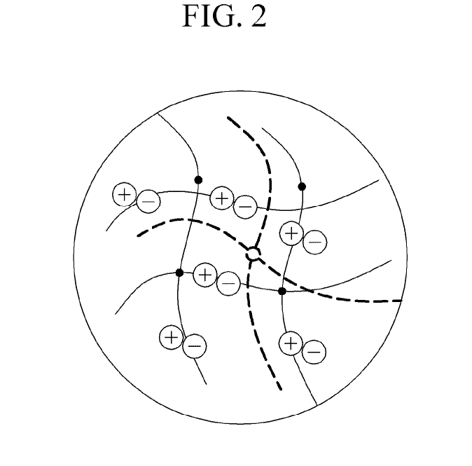

The structure of such an IPN polymer is shown in FIG. 2.

Referring to FIG. 2, a solid line indicates the aforementioned cross-linked polymer including a zwitterionic monomer, in which a cationic group and an anionic group are marked together. On the other hand, a dotted line in FIG. 2 indicates a cross-linked polymer obtained by cross-linking polymerizing a temperature-sensitive monomer. Accordingly, the cross-linked polymer including a zwitterionic monomer and the cross-linked polymer including a temperature-sensitive monomer form an interpenetrating polymer network (IPN). This IPN polymer has different characteristics from a copolymer prepared by simply copolymerizing a temperature-sensitive monomer and a zwitterionic monomer as subsequently described herein.

In another example embodiment, a draw solute for forward osmosis may include a polymer hydrogel where a first cross-linked polymer (including a zwitterionic monomer including an anionic group and a cationic group) and a second cross-linked polymer (including a temperature-sensitive monomer) form interpenetrating polymer networks (IPN).

Since the cross-linked polymers formed from each monomer are interpenetrated into the polymer network (IPN) polymer, the polymer network (IPN) polymer may maintain characteristic of each monomer compared with a copolymer obtained by simply copolymerizing the two monomers and for example, a copolymer including a unit represented by the above Chemical Formula 8. Specifically, according to the example embodiment, a hydrogel polymer having interpenetrating polymer networks where a cross-linked polymer including zwitterionic monomer including an anionic group and a cationic group, and a cross-linked polymer including a temperature-sensitive monomer are interpenetrated into each other may have better temperature-sensitivity and higher hydrophilicity caused by an anionic group and a cationic group, compared with a cross-linking copolymer of a temperature-sensitive monomer and a zwitterionic monomer including an anionic group and a cationic group.

Accordingly, the polymer hydrogel having an interpenetrating polymer network where the cross-linked polymer including zwitterionic monomer and the cross-linked polymer including a temperature-sensitive monomer are interpenetrated into each other may be more swollen and have higher water recovery than a cross-linking copolymer obtained by simply copolymerizing a temperature-sensitive monomer and a zwitterionic monomer. Specifically, the interpenetrating polymer network polymer has a little lower water flux than the polymer hydrogel represented by the above Chemical Formula 8 but a higher water recovery rate and resultantly, high water treatment capability.

Another example embodiment relates to a forward osmosis water treatment device including the draw solute for forward osmosis.

Specifically, the forward osmosis water treatment device may include a chamber including a first part for receiving a feed solution including subject materials to be separated for purification, and a second part for receiving an osmosis draw solution including a draw solute for forward osmosis; a semi-permeable membrane disposed between the first part and the second part in the chamber, one side being toward the first part and the other side being toward the second part; and a recovery system for separating and recovering the draw solute for forward osmosis from the osmosis draw solution, wherein the draw solute for forward osmosis is attached to the surface of the semi-permeable membrane toward the second part.

In the forward osmosis water treatment device, a recovery system for separating and recovering the draw solute for forward osmosis from the osmosis draw solution may include a heating equipment for heating the temperature-sensitive monomer of the draw solute for forward osmosis up to a temperature of greater than or equal to LCST.

The forward osmosis water treatment device may further include an outlet for producing treated water of the rest of the osmosis draw solution after the draw solute is separated by the recovery system, which includes water that has passed through the semi-permeable membrane from the feed solution by osmotic pressure.

The semi-permeable membrane is a semi-permeable separation membrane for forward osmosis which is permeable for water and non-permeable for the subject materials to be separated.

In one example embodiment, the semi-permeable membrane may use any material in this art, for example polystyrene (PS), and the like.

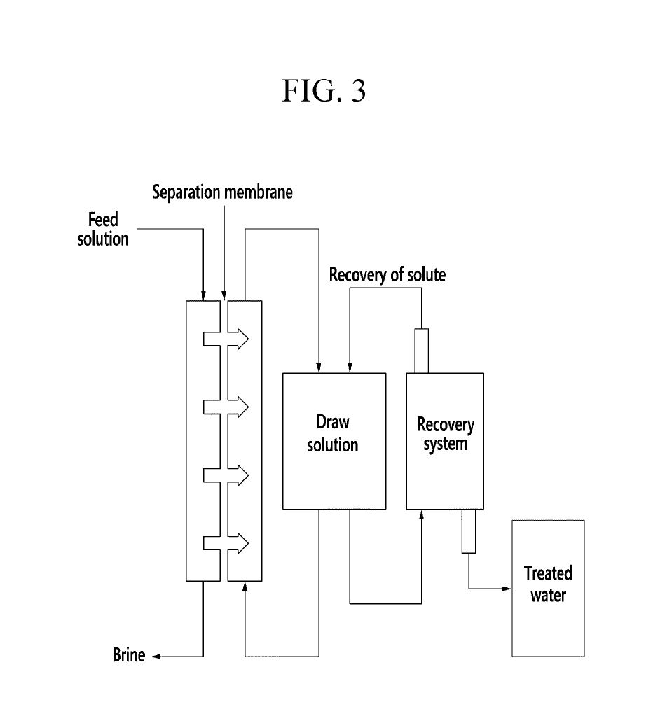

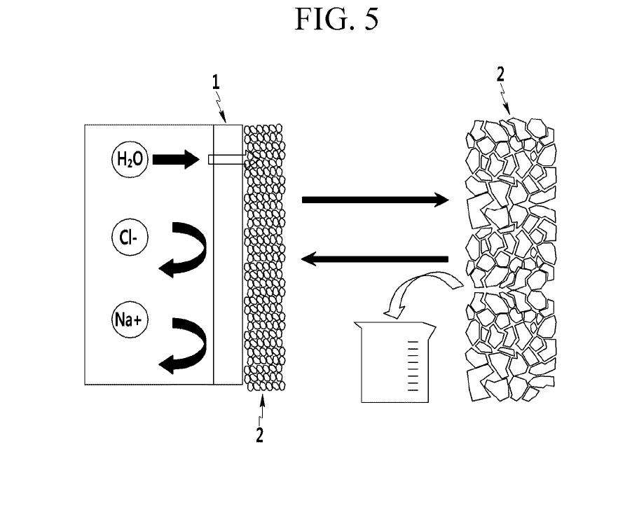

FIG. 3 schematically shows the forward osmosis water treatment device, and FIG. 5 is a schematic view showing a forward osmosis water treatment device manufactured by adhering the draw solute for forward osmosis to the rear of the semi-permeable membrane.

As described in the above example embodiment, the draw solute for forward osmosis may include a polymer hydrogel including a copolymer of a zwitterionic monomer including an anionic group and a cationic group, and a temperature-sensitive monomer; or a polymer hydrogel including interpenetrating polymer networks (IPN) of a cross-linked polymer including zwitterionic monomer including an anionic group and a cationic group, and a cross-linked polymer including a temperature-sensitive monomer.

The draw solute for forward osmosis may be a solute dissolved in an osmosis draw solution, or a hydrogel that is present as a solid before contacting with water passing a separation membrane from a feed solution but taking up the water passing the separation membrane and swollen. Specifically, in the forward osmosis water treatment device, the draw solute for forward osmosis, for example, the copolymer or the IPN polymer hydrogel may be attached to one side of the semi-permeable membrane. More specifically, the copolymer or the IPN polymer hydrogel may be adhered to one side of the semi-permeable membrane and present in the second part for receiving osmosis draw solution in the chamber.

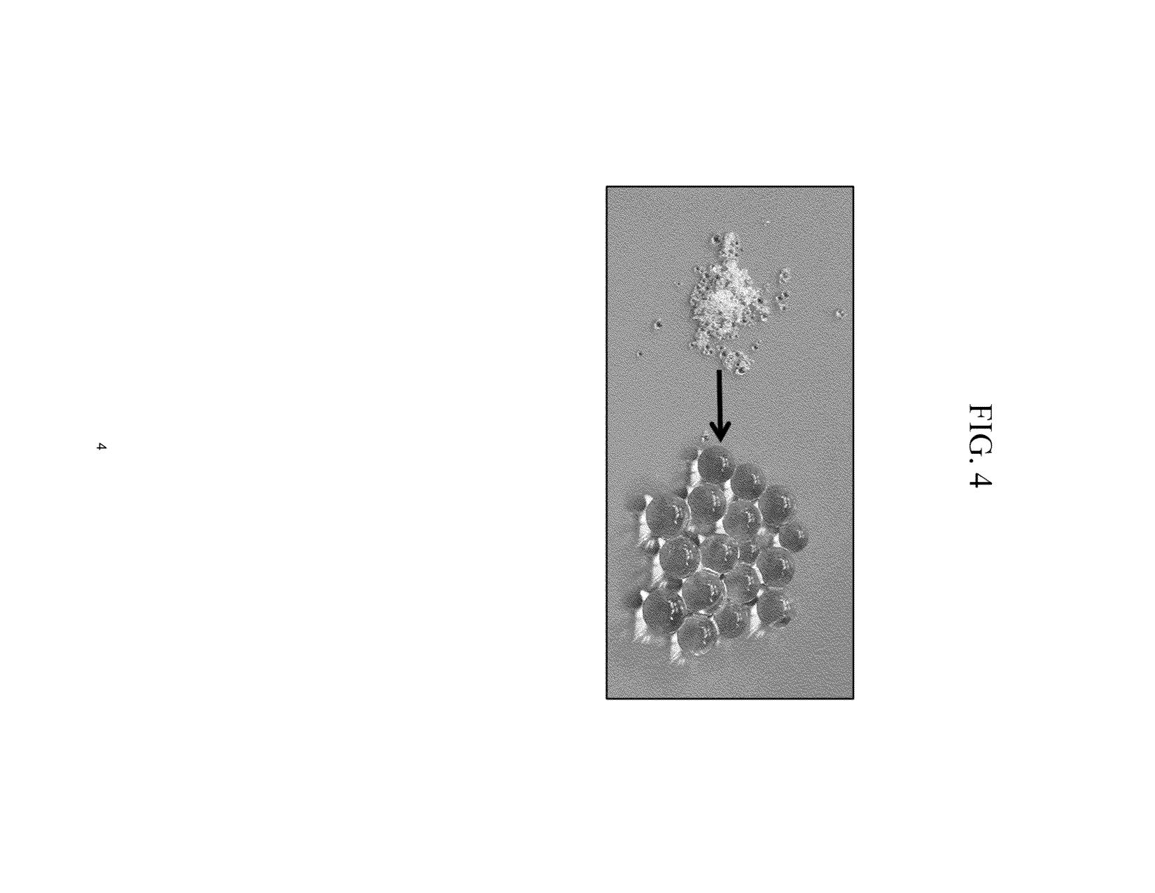

As shown in FIG. 4, the IPN polymer according to the example embodiment has a different shape before taking up water and after taking up the water and thus, being swollen. In other words, the left side of FIG. 4 shows an osmosis draw solute in a solid powder state before water uptake, while the right side of FIG. 4 shows an IPN polymer hydrogel swollen after the water uptake. Accordingly, the IPN polymer powder according to an example embodiment is adhered to one side of a semi-permeable membrane, and the side of the semi-permeable membrane contacting the IPN polymer powder is positioned in the osmosis draw solution receiving part of a forward osmosis water treatment device, while the other side of the semi-permeable membrane not contacting the IPN polymer powder is positioned in the feed solution receiving part.

Herein, when the feed solution receiving part is supplied with a feed solution, the IPN polymer takes up water passing through the semi-permeable membrane. The water in the feed solution keeps passing through the separation membrane due to osmotic pressure of the forward osmosis draw solute (an IPN polymer and the like) and is absorbed in the IPN polymer adhered to the rear of the separation membrane. When the water passing through the semi-permeable membrane from the feed solution is taken up into the IPN polymer, the IPN polymer is swollen by the water. When the swollen IPN polymer hydrogel is separated and heated up to a temperature of greater than or equal to LOST or the pH thereof is changed, the IPN polymer may be self-agglomerated, and the purified water taken up by the IPN polymer may be separated. In addition, the dehydrated polymer hydrogel may be recovered and reused.

FIG. 5 is a schematic view showing a forward osmosis water treatment device using the IPN polymer hydrogel as an osmosis draw solute.

The left side of FIG. 5 shows a forward osmosis water treatment device using a separation membrane manufactured by adhering the polymer hydrogel 2 to one side of the semi-permeable membrane 1. When a feed solution including a salt ion such as Na⁺ and Cl⁻ is introduced into the feed solution receiving part on the left side of the semi-permeable membrane 1, water in the feed solution passes through the semi-permeable membrane 1 and moves toward the hydrogel 2, while the salt (e.g., Na⁺ and Cl⁻) does not pass the semi-permeable membrane 1 but remains in the feed solution receiving part. When water in the feed solution keeps moving toward the hydrogel 2, the polymer hydrogel 2 adhered to the separation membrane takes up the water and is swollen. Then, the swollen polymer hydrogel 2 is separated and heated up to a temperature of greater than or equal to LOST to obtain purified water therefrom as shown in the right side of the drawing.

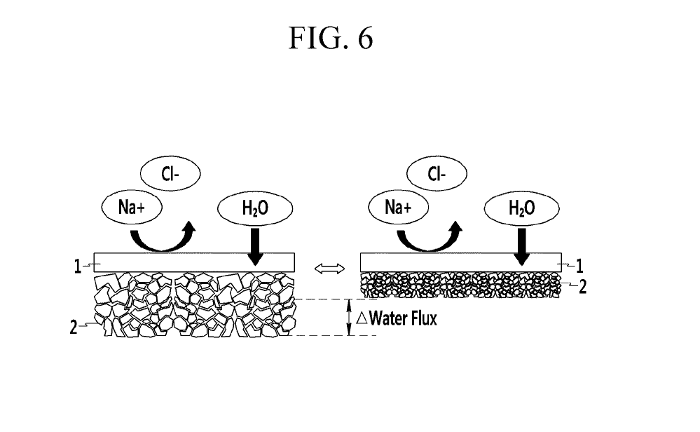

On the other hand, when the polymer hydrogel 2 as a forward osmosis draw solute is adhered to a semi-permeable membrane 1, the water flux of the polymer hydrogel 2 is provided in FIG. 6. In other words, the water flux is the amount of water passing the semi-permeable membrane 1, taken up by the polymer hydrogel 2 and swelling the polymer hydrogel 2, and then, separated from the polymer hydrogel 2 when the polymer hydrogel 2 is heated up to a temperature of greater than or equal to LOST and agglomerated.

According to an example embodiment, the osmosis draw solution receiving part in the forward osmosis water treatment device may be provided with a draw material for the forward osmosis, that is, an osmosis draw solution including a copolymer or an IPN polymer hydrogel according to the example embodiment and also, a conjugate base for the copolymer or the IPN polymer hydrogel.

In another example embodiment, a forward osmosis method for water treatment using the osmosis draw solute is provided.

Specifically, the forward osmosis method for water treatment may separate and recover pure water by adhering a polymer hydrogel according to an example embodiment as a forward osmosis draw solute to one side of a semi-permeable membrane and introducing a feed solution toward the semi-permeable membrane, so that the water in the feed solution may be taken up by the semi-permeable membrane, pass the semi-permeable membrane, and then, is taken up by the polymer hydrogel, the osmosis draw solute, that is adhered to the rear of the semi-permeable membrane, and thereby when higher osmotic pressure occurs than the feed solution by the polymer hydrogel, the water in the feed solution that keeps passing the semi-permeable membrane may be taken up by the polymer hydrogel again. Then, the swollen polymer hydrogel by taking up the water is separated and heated up to a temperature of greater than or equal to a low critical solution temperature (LOST) and then, the polymer hydrogel is self-agglomerated, separating and recovering the water purified through the semi-permeable membrane. Herein, the dehydrated polymer hydrogel is readhered to the semi-permeable membrane and reused for the forward osmosis water treatment process.

The example embodiment illustrates adherence of the polymer hydrogel to the rear of a semi-permeable membrane, but the copolymer or polymer hydrogel may be used as a solute in an osmosis draw solution to perform a forward osmosis water treatment process.

As illustrated above, the forward osmosis method for water treatment using an osmosis draw solute according to one example embodiment has an advantage of easily separating treated water by regulating a temperature by simply separating a draw solute or a swollen polymer hydrogel and reusing the separated draw solute from the water. In particular, the draw solute may be separated without a complex method using an additional filter and the like.

The feed solution may be sea water, brackish water, ground water, waste water, and the like. For example, sea water may be purified with the forward osmosis water treatment device to obtain drinking water.

Hereinafter, the present disclosure is illustrated in more detail with reference to the following examples. However, these embodiments are merely examples, and the present disclosure is not limited thereto.

### EXAMPLES

### Example 1

### Preparation of Poly(NIPAAm-co-SSP) Ionic Hydrogel by Copolymerizing Temperature-Sensitive Monomer and Zwitterionic Monomer

A poly(NIPAAm-co-SSP) ionic hydrogel is prepared by the following method in order to see what influence the temperature-sensitive material including a zwitterionic monomer has on a forward osmosis draw effect and an economical recovery (water recovery).

(a) First, two monomers of N-isopropylacrylamide (NIPAAm, 7.1×10⁻³ mol) and N,N-dimethyl-N-methacrylamidopropyl ammoniopropane sulfonate (SSP, 2.4×10⁻³ mol), a cross-linking agent of N,N′-methylenebisacrylamide (MBAAm, 9.5×10⁻⁵ mol), and a photopolymerization initiator of Irgacure 2959 (1.9×10⁻⁴ mol) are dissolved in 8.5 g of water, and the solution is connected to a vacuum pump to remove a vapor therefrom.

(b) A closed system is manufactured by making a frame by making a circular hole (a diameter of 2 cm, a height of 5 mm) in a silicon plate and then, putting two glass plates on the frame and fixing them with pincers.

(c) The solution (a) is put in the silicon frame (b), and the solution is exposed to a UV lamp (Spectroline EN-180/FE, a long wave lamp) for 4 hours for photo-cross-linking.

(d) The cross-linked hydrogel is added to water whose weight is five times as many as the hydrogel to remove the non-reacted monomers and the initiator. The water is three times exchanged for one day, and room temperature is maintained during the reaction.

The polymer is polymerized according to the following Reaction Scheme:

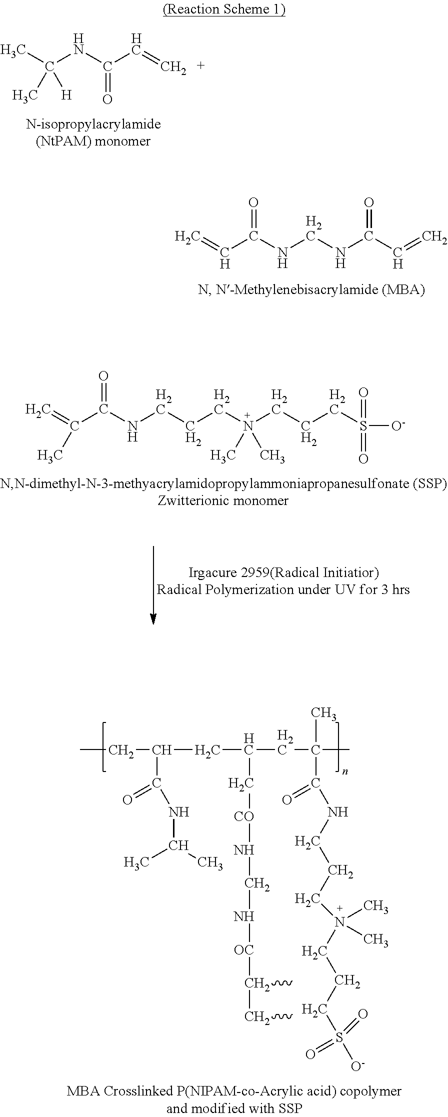

The zwitterionic PNIPAAm-co-SSP copolymer prepared according to the aforementioned method turns out to have improved forward osmosis draw effect and water recovery rate compared with a polymer (PNIAm) prepared by using only polyacrylic acid amide or a temperature-sensitive monomer (refer to the following Table 1).

### Example 2

### Preparation of IPN (Interpenetrating Polymer Network) Polymer Hydrogel of Poly(NIPAAm)-SSP

An interpenetrating polymer network (IPN) polymer is prepared by using a zwitterionic monomer and a temperature-sensitive material according to the following method to see what influence the interpenetrating polymer network polymer has on a forward osmosis draw effect, an economical recovery (water recovery), and property.

(a) Acrylic acid (AAc, 2.8×10⁻² mol), a cross-linking agent (MBAAm, 5.6×10−4 mol), and a polymerization initiator (Irgacure 2959, 2.8×10⁻⁴ mol) are dissolved in 18 g of water.

(b) The solution (a) is put in a silicon frame according to the (b) in Example 1, and the solution is exposed to a UV lamp for 2 hours for photo-cross-linking and then, put in water whose weight is five times as many as the solution to remove the non-reacted monomer and initiator therein.

(c) The cross-linked hydrogel in the (b) is added to 30 ml of anhydrous chloroform, and 13 mmol of 1,1-carbonyldiimidazol (CM) is additionally added thereto. The mixture is agitated at room temperature for 20 minutes under a nitrogen gas atmosphere.

(d) The solution obtained in the (c) is put in an ice bath, and 50 mmol of N,N′-dimethylethylene diamine (DMED) is added thereto. The mixture is agitated for 2 hours under a nitrogen atmosphere.

(e) The obtained gel is three times washed with 80 ml of a 10% NaCl solution and twice with 80 ml of 10 mM NaOH and then, dried for one day.

(f) The dried gel (e) is added to 30 ml of anhydrous chloroform, and 15 mmol of 1,3-propanesulton is added thereto. The mixture is agitated for 24 hours and washed with anhydrous chloroform again.

(g) The SSP hydrogel synthesized in the (f) is put in a solution prepared by dissolving NIPAAm (2.8×10⁻² mol), MBAAm (5.6×10−4 mol), and Irgacure 2959 (2.8×10⁻⁴ mol) in 17 g of water and then, sufficiently swollen.

(h) The swollen gel is put in a silicon frame according to the (b) in Example 1 and exposed to a UV lamp for 2 hours for photo-cross-linking.

(i) The final product, IPN, is put in water whose weight is five times as many as the IPN to remove the non-reacted monomer and initiator. The water is three times exchanged for one day, and room temperature is maintained during the reaction.

On the other hand, the zwitterionic monomer, SSP, (N,N-dimethyl-N-methacryl amidopropyl ammoniopropane sulfonate) is prepared from AAc (acrylic acid) according to the following Reaction Scheme:

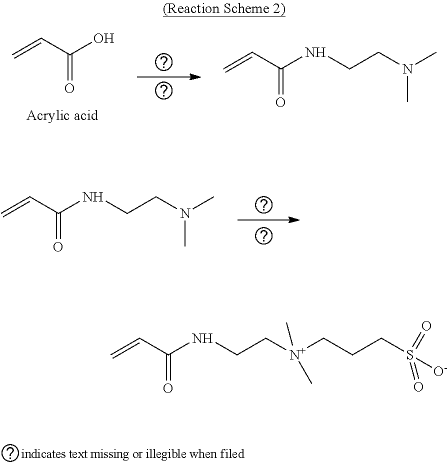

The aforementioned zwitterionic PNIPAAm-AAc IPN hydrogel has improved forward osmosis draw effect and water recovery rate compared with a polymer (PNIAm) prepared by using only polyacrylic acid amide or a temperature-sensitive monomer (refer to the following Table 1).

### Example 3

### Preparation of IPN (Interpenetrating Polymer Network Polymer) Hydrogel of Poly(NIPAAm)-SSP

An interpenetrating polymer network polymer (IPN) is prepared by using a zwitterionic monomer and a temperature-sensitive material according to the following method to see what influence the interpenetrating polymer network polymer has on a forward osmosis draw effect and an economical recovery (water recovery).

(a) NIPAAm (1.5×10⁻² mol), MBAAm (1.5×10⁻⁴ mol), and Irgacure 2959 (3.0×10⁻⁴ mol) are dissolved in 8.3 g of water, and the solution is connected to a vacuum pump to remove a vapor therefrom.

(b) SSP (0.5×10⁻² mol), MBAAm (1.0×10⁻⁴ mol), and Irgacure 2959 (1.0×10⁻⁴ mol) are dissolved in 8.5 g of water.

(c) The solution prepared in the (b) is put in a silicon frame according to the (b) in Example 1 and exposed to a UV lamp for 4 hours for photo-cross-linking and then, vacuum-dried.

(d) The cross-linked hydrogel obtained in the (c) is put in the solution (a) and then, sufficiently swollen for a half day.

(e) The swollen gel is put in the silicon frame according to the (b) in Example 1 and exposed to a UV lamp for 2 hours for photo-cross-linking.

(f) The final product, IPN, is added to water whose weight is five times as many as the IPN to remove the non-reacted monomer and initiator therefrom. The water is three times exchanged for one day, and room temperature is maintained during the reaction.

### Example 4

### Preparation of Hydrogel Adhered to Membrane

The hydrogels according to Examples 1 to 3 are respectively adhered to a PS membrane, manufacturing a hydrogel system adhered to a membrane.

In addition, polyacrylic acid amide (PAA) prepared using only acrylamide, PNIPAam prepared by using only a temperature-sensitive monomer, NIPAM, and a PNIPAam-AA hydrogel prepared by copolymerizing the PNIPAam and acrylic acid (AA) are respectively adhered to a PS membrane according to the same method as aforementioned, manufacturing a hydrogel system adhered to a membrane.

In addition, the PNIPAam-AA-SPP hydrogel prepared using the PNIPAam-AA copolymer and a temperature-sensitive monomer SPP (N,N-dimethyl-N-methacrylamidopropylammoniopropanesulfonate) into an interpenetrating polymer network (IPN) polymer according to the same method as Example 3 is adhered to a PS membrane in the same method as aforementioned, manufacturing a hydrogel system adhered to a membrane.

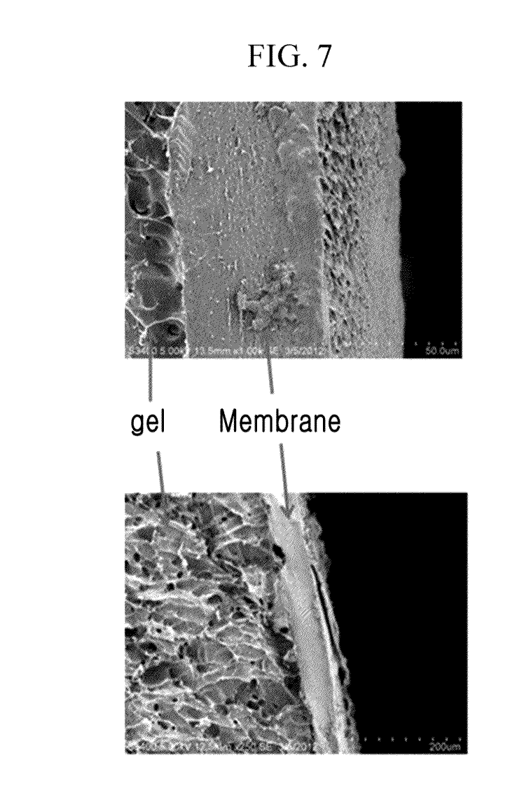

FIG. 7 is a scanning electron microscope (SEM) photograph showing a separation membrane manufactured by adhering the IPN polymer to a PS membrane.

Evaluation

### Experimental Example 1

### Polymer Analysis Using FT-IR

The hydrogels according to Examples 1 to 3 are examined whether or not a polymer is produced by checking production of a C═O bond through FT-IR. The examination shows that a polymer is produced in each Example.

### Experimental Example 2

### Swelling Ratio of Polymer

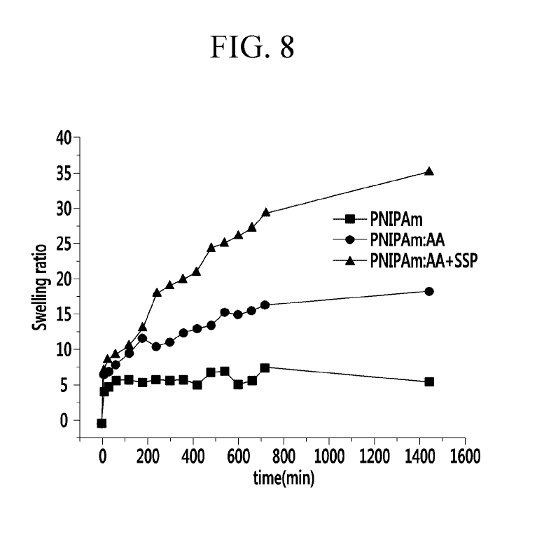

Each polymer is measured regarding swelling ratio to compare water uptake of a temperature-sensitive monomer, a PNIPAam:AA (acrylic acid amide) cross-linking copolymer prepared by copolymerizing acrylic acid amide with the temperature-sensitive monomer, PNIPAm, and the polymer (PNIPAm:AA-SSP) prepared by polymerizing a zwitterionic monomer, SSP, with the PNIPAM:AA into IPN. As a result, the IPN polymer PNIPAm:AA-SSP having a zwitterionic functional group has the highest water uptake efficiency (FIG. 8).

### Experimental Example 3

### Comparison of Swelling ratios of IPN and Non-IPN Structure Hydrogels

The IPN structure hydrogel according to Example 2 or 3 has higher water uptake and dehydration ratios depending on a temperature than a non-IPN structure hydrogel (Table 1).

TABLE 1

| | 4° C. | 50° C. |
|---|---|---|
| Hydrogel of Example 1: P(NIPAAM-co-SSP) | 190 g | 130 g |
| IPN Poly(NIPAAm)-SSP hydrogel of Example 2 | 660 g | 340 g |

### Experimental Example 4

### Swelling Characteristic of Hydrogel Depending on Salt (Hofmeister Series Test)

The IPN hydrogel according to Example 2 is examined regarding swelling characteristic depending on kinds of a salt. The examination is performed as follows:

1. The IPN hydrogel is dipped in water for 24 hours in an 8° C. refrigerator to absorb water.

2. The IPN hydrogel is dipped in a 1M salt solution for 24 hours in an 8° C. refrigerator to absorb water.

3. The gel is taken out from the solution and washed with distilled water on the surface and then, dipped in distilled water again and stored in a 50° C. oven for 24 hours.

4. Then, the gel is stored in the 8° C. refrigerator for 48 hours and then, examined.

The following Table 2 provides the swelling ratio measurements of the IPN hydrogel according to Example 2 depending on kinds of a salt

The IPN hydrogel has the highest swelling ratio when NaF, NaCl, NaBr, and NaNO₃ as a salt are used.

TABLE 2

| | Na₂CO₃ | Na₂S₂O₃ | NaH₂PO₄ | NaF | NaCl | NaBr | NaNO₃ | Nal | NaSCN |
|---|---|---|---|---|---|---|---|---|---|
| 25° C. | 0.33 g | 0.65 g | 1.04 g | 1.36 g | 2.35 g | 2.38 g | 2.41 g | 2.19 g | 2.94 g |
| After | 0.14 g | 0.24 g | 0.26 g | 0.15 g | 0.23 g | 0.33 g | 0.29 g | 0.39 g | 0.35 g |
| drying | | | | | | | | | |
| Swelling | 135 | 170 | 300 | 806 | 921 | 621 | 731 | 461 | 740 |
| ratio (%) | | | | | | | | | |

### Experimental Example 5

### Water Flux of Hydrogel System

Each hydrogel is measured regarding water flux by adhering each polymer hydrogel to a PS membrane to fabricate a hydrogel system adhered to a membrane as shown in Example 4, making the top diameter of the hydrogel into 3 cm, and passing water through each hydrogel system and then, measuring the weight of the hydrogel depending on time and converting the measurements into a water flux. Then, the water flux is used to calculate water recovery rate of each hydrogel.

The water recovery rate (%) is calculated by subtracting the water uptake amount of each hydrogel system at 50° C. from the water uptake amount of each hydrogel system at 8° C. and dividing the obtained difference by the water uptake amount of each hydrogel system at 8° C. In other words, the water recovery rate (%) is obtained according to the following equation 1:

Water recovery rate (%)={(water uptake amount at 8° C.−water uptake amount at 50° C.)/water uptake amount at 8° C.}×100 (Equation 1)

The measurement results are provided in the following Table 3.

TABLE 3

| Kinds of | Water flux | Water | Total |
|---|---|---|---|
| hydrogel | (mg/cm² * hr) | recovery rate (%) | efficiency |
| PAA | 4.9 | −83% | −4.07 |
| PNIPAm | 1.8 | 68% | 1.23 |
| P(NIPAam-co-SSP) | 8.5 | 19% | 1.59 |
| IPN polymer | 6.2 | 58% | 3.58 |

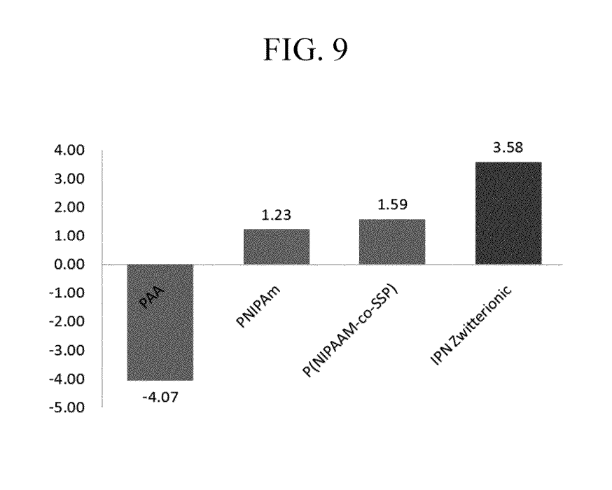

As shown from the table, the hydrogel system adhered to a membrane including the IPN structure polymer prepared using a temperature-sensitive monomer and a zwitterionic monomer according to Example 2 or 3 has the most excellent total efficiency compared with a temperature-sensitive monomer, PNIPAm, or a polymer P (NIPAam-co-SSP) prepared copolymerizing the temperature-sensitive monomer, PNIPAm, with an amphiphilic monomer. FIG. 9 is a graph showing the result.

While this disclosure has been described in connection with various examples, it is to be understood that the disclosure is not limited to the disclosed embodiments, but, on the contrary, is intended to cover various modifications and equivalent arrangements included within the spirit and scope of the appended claims.

What is claimed is:

1. A method of manufacturing a polymer hydrogel for an osmosis solute, comprising:
cross-linking polymerizing a zwitterionic monomer and a temperature-sensitive monomer, the zwitterionic monomer including an anionic group and a cationic group.

2. A method of manufacturing a polymer hydrogel for an osmosis solute having interpenetrating polymer networks (IPN), comprising
cross-linking polymerizing a zwitterionic monomer to form a zwitterionic polymer, the zwitterionic monomer including an anionic group and a cationic group, and
cross-linking polymerizing a temperature-sensitive monomer to form a temperature-sensitive polymer, one of the zwitterionic polymer and the temperature-sensitive polymer being initially formed as the first polymer and the other being subsequently formed as a second polymer in the presence of the first polymer to form the interpenetrating polymer networks.

3. The method of claim 2, wherein the zwitterionic monomer is represented by the following Chemical Formula 1: 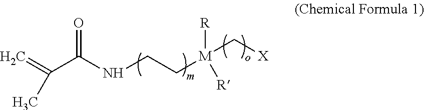
wherein X is the anionic group, M is the cationic group, R and R′ are independently a saturated or unsaturated monovalent organic group, m is an integer ranging from 0 to 10, and o is an integer ranging from 1 to 10.

4. The method of claim 3, wherein X is selected from —COO⁻, —CO₃⁻, —SO⁻₃, —SO₂⁻, —SO₂NH⁻, —NH₂⁻, —PO₃⁻², —PO₄⁻, —CH₂OPO₃⁻, —(CH₂O)₂PO₂⁻, —C₆H₄O⁻, —OSO₃⁻, —SO₂NR⁻, —SO₂NSO₂R^{—}, —SO₂CRSO₂R′⁻ (R and R′ are each independently a C1 to C4 alkyl or a C7 to C11 arylalkyl), 'Cl⁻, —Br, —SON⁻, —ClO⁴⁻ and a combination thereof.

5. The method of claim 3, wherein M is selected from an amino group, an ammonium group, a pyridinium group, and a combination thereof.

6. The method of claim 2, wherein the temperature-sensitive monomer is represented by one or more of the following Chemical Formula 2 to Chemical Formula 6:

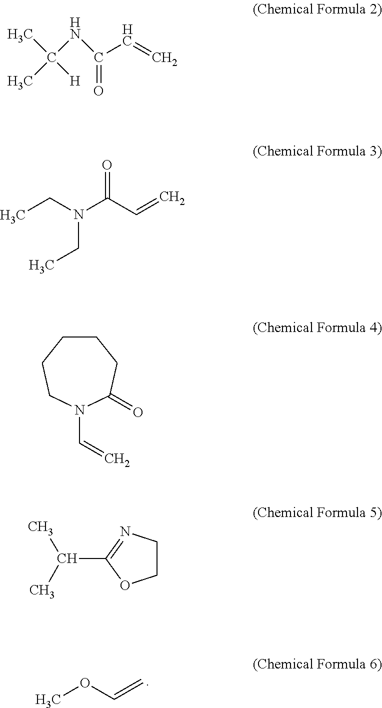

7. The method of claim 2, wherein the cross-linking polymerizing is performed using a cross-linking agent represented by the following Chemical Formula 7: 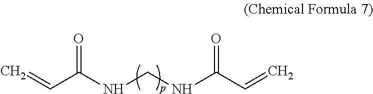
wherein p is an integer ranging from 1 to 10.

8. The method of claim 2, wherein the cross-linking polymerizing is performed in the presence of a photopolymerization initiator.

9. The method of claim 8, wherein the photopolymerization initiator is IRGACURE 2959 (2-hydroxy-1-[4-(2-hydroxyethoxy)phenyl]-2-methyl-1-propanone), IRGACURE 500 (1-Hydroxy-cyclohexyl-phenyl-ketone+benzophenone), or IRGACURE 754 (oxy-phenyl-acetic acid 2-[2 oxo-2 phenyl-acetoxy-ethoxy]-ethyl ester and oxy-phenyl-acetic 2-[2-hydroxy-ethoxy]-ethyl ester).

10. A draw solute for forward osmosis, comprising:
a polymer hydrogel including a unit represented by the following Chemical Formula 8: 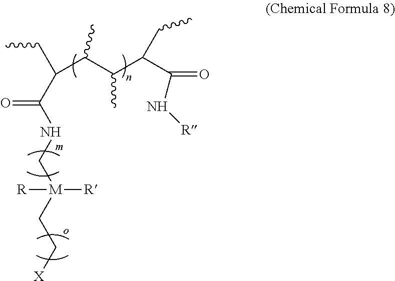
wherein R, R′, and R″ are independently a saturated or unsaturated monovalent organic group, X is an anionic group, M is a cationic group, m and o are the same or different and are integers ranging from 1 to 10, n is an integer ranging from 1 to 20, and [symbol] indicates a moiety linked to another moiety.

11. The method of claim 10, wherein R, R′ and R″ are independently a substituted or unsubstituted alkyl group, a substituted or unsubstituted alkenyl group, a substituted or unsubstituted alkynyl group, a substituted or unsubstituted aryl group, a substituted or unsubstituted arylalkyl group, a substituted or unsubstituted arylalkenyl group, or a substituted or unsubstituted arylalkynyl group.

12. A draw solute for forward osmosis, comprising:
a polymer hydrogel including interpenetrating polymer networks (IPN), the interpenetrating polymer networks formed of a first cross-linked polymer and a second cross-linked polymer, the first cross-linked polymer including a zwitterionic monomer, the zwitterionic monomer including an anionic group and a cationic group, the second cross-linked polymer including a temperature-sensitive monomer.

13. The draw solute for forward osmosis of claim 12, wherein the zwitterionic monomer is represented by the following Chemical Formula 1: 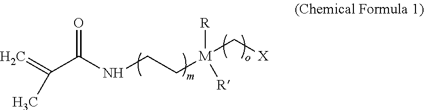
wherein X is the anionic group, M is the cationic group, R and R′ are independently a saturated or unsaturated monovalent organic group, m is an integer ranging from 0 to 10, and o is an integer ranging from 1 to 10.

14. The draw solute for forward osmosis of claim 13, wherein X is selected from —COO⁻, —CO₃⁻, —SO⁻₃, —SO₂⁻, —SO₂NH⁻, —NH₂⁻, —PO₃⁻², —PO₄⁻, —CH₂OPO₃⁻, —(CH₂O)₂PO₂⁻, —C₆H₄O⁻, —OSO₃⁻, —SO₂NR⁻, —SO₂NSO₂R⁻, —SO₂CRSO₂R′⁻ (wherein, R and R′ are each independently C1 to C4 alkyl or C7 to C11 arylalkyl), —Cl⁻, —Br, —SCN⁻, —ClO⁴⁻ and a combination thereof.

15. The draw solute for forward osmosis of claim 13, wherein M is selected from an amino group, an ammonium group, a pyridinium group, and a combination thereof.

16. The draw solute for forward osmosis of claim 12, wherein the temperature-sensitive monomer is represented by one or more of the following Chemical Formula 2 to Chemical Formula 6:

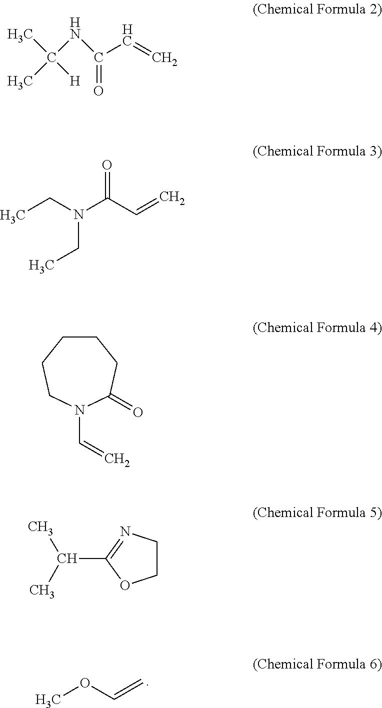

17. The draw solute for forward osmosis of claim 12, wherein the first and second cross-linked polymers are cross-linking polymerized with a cross-linking agent represented by the following Chemical Formula 7: 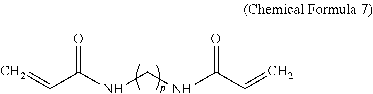
wherein p is an integer ranging from 1 to 10.

18. A water treatment device for forward osmosis, comprising the draw solute for forward osmosis of claim 12.

19. The water treatment device for forward osmosis of claim 18, further comprising:
a chamber including a first part and a second part, the first part configured to receive a feed solution including subject materials to be separated for purification, the second part configured to receive an osmosis draw solution including the draw solute for forward osmosis;
a semi-permeable membrane disposed between the first part and the second part of the chamber, a first side of the semi-permeable membrane facing the first part of the chamber and a second side of the semi-permeable membrane facing the second part of the chamber; and
a recovery system configured to separate and recover the draw solute for forward osmosis from the osmosis draw solution,
wherein the draw solute for forward osmosis is attached to the second side of the semi-permeable membrane facing the second part of the chamber.

20. A forward osmosis method for water treatment using the water treatment device for forward osmosis of claim 18.
